(19) United States
(12) Patent Application Publication
(10) Pub. No.: US 2023/0366467 A1
(43) Pub. Date: Nov. 16, 2023

(54) METHOD OF PRODUCING FLEXIBLE SEALS AND FLEXIBLE SEALS PRODUCED THEREFROM

(71) Applicant: CHAIRMAN, DEFENCE RESEARCH & DEVELOPMENT ORGANISATION, New Delhi (IN)

(72) Inventors: Sundar Singh PALAPARTHI, Hyderabad (IN); Rama Rao GOLLA, Hyderabad (IN); Manoj Kumar BURAGOHAIN, Hyderabad (IN)

(21) Appl. No.: 18/041,068

(22) PCT Filed: Oct. 25, 2021
(86) PCT No.: PCT/IN2021/051011

§ 371 Date: Feb. 8, 2023

(30) Foreign Application Priority Data
Oct. 29, 2020 (IN) 202011047359

(51) Int. Cl. F16J 15/328; B29D 99/00; B32B 1/00; B32B 5/02; B32B 5/26; F16J 15/3284

(52) U.S. Cl. CPC F16J 15/328; B29D 99/0053; B32B 1/00; B32B 5/02; B32B 5/26; F16J 15/3284; B29K 2063/00

(57) ABSTRACT

A method of making a flexible seal includes obtaining rigid shims, wherein each rigid shim is a resin impregnated fabric having a three-dimensional structure comprising fibers disposed in three-dimensions. The rigid shims are stacked with intermediate elastomer layers to form alternate layers of intermediate elastomer layer and rigid shim. The stack of rigid shims and intermediate elastomer layer in a seal mold. The intermediate elastomer layers are cured to obtain the flexible seal having alternate layers of rigid shims and elastomer layers. Flexible seals prepared according to the method are also contemplated.

### TECHNICAL FIELD

The present subject matter relates generally to seals and in particular to flexible seals and a method of making flexible seals.

### BACKGROUND

Seals used in joining parts, for example, in rockets, must be flexible but at the same time have sufficient mechanical strength to bear the stresses placed on the seal. The seals are generally made using a rigid component for reinforcement and a flexible component, with alternate layers of the two components attached to each other to form the seal. However, use of rigid components increases the weight of the seal even though it provides mechanical strength, which is a disadvantage in applications such as rockets where weight of parts is a critical factor.

### BRIEF DESCRIPTION OF THE SEVERAL VIEWS OF THE DRAWINGS

The detailed description is described with reference to the accompanying figures. In the figures, the left-most digit(s) of a reference number identifies the figure in which the reference number first appears. The same numbers are used throughout the drawings to reference like features and components where possible.

FIG. 1 illustrates a partial sectional view of an example seal, in accordance with an embodiment of the present subject matter.

FIG. 2 illustrates a top view of a resin impregnated cloth, in accordance with an embodiment of the present subject matter.

FIG. 3 illustrates an example female mold, in accordance with an embodiment of the present subject matter.

FIG. 4(a) illustrates an example bundle of strips formed by laying down strips of a resin impregnated cloth in a female mold and FIG. 4(b) illustrates an exploded view of a portion of the bundle of strips, in accordance with an embodiment of the present subject matter.

FIG. 5 illustrates an example male mold, in accordance with an embodiment of the present subject matter.

FIG. 6 illustrates an example mold base with a male mold and a female mold, in accordance with an embodiment of the present subject matter.

FIG. 7 illustrates an example shim after curing, in accordance with an embodiment of the present subject matter.

FIG. 8 illustrates a cross-sectional view of a seal mold for preparing an example flexible seal, in accordance with an embodiment of the present subject matter.

FIG. 9(a) illustrates a schematic illustration of preparing an example rigid shim using a preform, in accordance with an embodiment of the present subject matter.

FIG. 9(b) illustrates a schematic illustration of a method of resin impregnation in an example preform, in accordance with an embodiment of the present subject matter

### DETAILED DESCRIPTION

The present subject matter relates to flexible seals and a method of making flexible seals. Seals used in several applications, such as in rockets, need to be flexible and at the same time mechanically robust. Mechanical strength may be obtained by including rigid components in the seal. However, adding rigid components increases the weight of the seal, which becomes a concern in rockets, for example.

Typically, flexible seals employed in a thrust nozzle for rockets have laminates of alternate layers of rigid and elastomer material between the end rings and are sufficiently thick to contain enough elastomer to permit the required degree of angular displacement. To increase the load bearing capacity of the thick elastomer, it is divided into several thin layers, requiring an almost equal number of rigid shims. Since each shim conforms to the surface of an individually associated sphere having its own unique radius, therefore each shim is prefabricated from an individually identified mold. Thus, several molds are required for realizing all the shims of a particular flexible seal. In addition, thin reinforcement shims inherently lack the desired rigidity, dimensional stability, and are also susceptible to distortion due to the release of internal stresses after molding. Thick layers of elastomer and shims tend to have high shear stress in the flexible seal components.

Moreover, cured reinforced plastic shims have low lamination strength. In rocket applications, during the vectoring of a rocket nozzle, there is a possibility of the flexible seal being subjected to axial pull, which causes the layers of the cured reinforced plastic shim to be peeled, resulting in delamination. Furthermore, seals also need to be protected from thermal environments.

The weight of the seal is also a concern and has been reduced in different ways previously. For example, conventionally, some rigid shims used as reinforcement were replaced by flexible reinforcements or the rigid shims were eliminated. A significant reduction in seal weight was achieved by using a pliable fabric strip for the reinforcement, thus reducing the reinforcement structural requirement of the seal such that compressive circumferential loads are carried by the supporting structure. However, the usability of flexible reinforcing shims is limited depending on loading conditions and stiffness limitations. Generally, it is desired that the shims possess a certain degree of rigidity and be strong enough to be assembled to a thrust nozzle.

Some conventional processes have tried to overcome the above limitations of flexible seals using layering; however, the process needs to be done manually, requires skill, is laborious, and is time consuming. Furthermore, during layup in the green condition (i.e., prior to curing), while being installed in the mold for curing, the layers may slide, giving rise to folds in the cured component.

Reinforced plastic shims were also realized in conventional methods, where multiple quarter circles were cut or stamped from a pre-impregnated fabric sheet. During layup of such quarter circle plies in the female mold, a large number of joints occur in a layer. Also, the molding process is laborious, and the shims realized were defective and weak compared to those realized by continuous ply layup.

In another conventional method of making a flexible seal, each layer of reinforcement deposited on a layer of elastomer is formed by winding a resin pre-impregnated thread directly onto the underlying layer of elastomer. While the method has led to reduced operating and manufacturing costs, there is, however a need for reinforcing along the thickness, such that vectoring loads might not induce delamination within the thickness of the shim.

Thus, there is a need for realizing a reinforced plastic shim by a simple process, having sufficient thickness to be dimensionally stable and capable of overcoming delaminating and shear forces that are encountered during operation of the flexible seal.

The present subject matter relates to a method of making flexible seals and flexible seals produced therefrom. A rigid shim is obtained, wherein the rigid shim comprises a resin impregnated and cured fabric, the fabric having a three-dimensional structure comprising fibers disposed in three-dimensions. The method further includes stacking the rigid shims with intermediate elastomer layers to form alternate layers of intermediate elastomer and rigid shim; placing the stack of rigid shims and intermediate elastomer layers in a seal mold; and curing the intermediate elastomer layers to form the flexible seal with alternate rigid shims and elastormer layers. The flexible seal thus formed comprises a cured stack of layers of rigid shims alternating with elastomer layers, wherein the rigid shims comprise a cured resin-impregnated three-dimensional fabric having fibers disposed in three dimensions.

In one example, the rigid shim is prepared by impregnating a preform of the three-dimensional fabric with a resin and then curing it in a mold. In another example, the rigid shim is prepared by cutting a cloth impregnated with resin into strips and laying each of the strips around an inner circumference of a female mold in a layer by layer manner to form layered strips. The layered strips may be fastened together through the thickness of the layered strips to form a bundle of strips. The bundle of strips thus forms a fabric having three-dimensional structure. The female mold comprising the bundle of strips and a corresponding male mold may be placed in a mold base. The bundle of strips may be then cured to obtain the rigid shim.

The method of the present subject matter makes the process simpler than conventional processes and reduces the number of shims by using thick shims and elastomer layers, thereby reducing the number of shim molds to be used and thus, significantly reducing the manufacturing time and cost. The shims realized after demolding are rigid, dimensionally stable, and strong. The shims are not susceptible to distortion, warpage, and buckling. Fastening the layers of the strips together, for example by stitching, enables the cured shim to possess higher inter-laminar shear strength and makes it more tolerant to damage. A fiber roving passing across the thickness of the stack when fastening using stitching, binds the strips together to prevent delamination within the shim when the flexible seal is subjected to axial pull during nozzle vectoring. The present method also improves inter-laminar shear strength, whereby chances of delamination within the shim is eliminated when the seal is subjected to pressure and vectoring loads.

Reinforcement shims made according to the present subject matter are thus pliable to enable load transfer to the supporting structure. The shims are thick enough that they are dimensionally stable, strong, and stiff enough to bear the required compressive circumferential loads. An increase in the thickness of the rigid shim reduces the number of shims for a given elastomer thickness required for deflection. Correspondingly, the number of shim molding tools are also reduced. The shims are also free from delamination when the seal is subjected to pressure and vectoring loads. The shims may also extend beyond the resilient layers to form a protective heat and flame barrier, whereby the requirement of a thermal protective boot is eliminated, and weight of the flexible seal may be further reduced. In the absence of a thermal boot, the actuating load is also reduced and requires a small capacity actuator.

Aspects of the present subject matter are further described in conjunction with the appended figures. It should be noted that the description and figures merely illustrate the principles of the present subject matter. It will thus be appreciated that various arrangements that embody the principles of the present subject matter, although not explicitly described or shown herein, can be devised from the description and are included within its scope. Moreover, all statements herein reciting principles, aspects, and implementations of the present subject matter, as well as specific examples thereof, are intended to encompass equivalents thereof

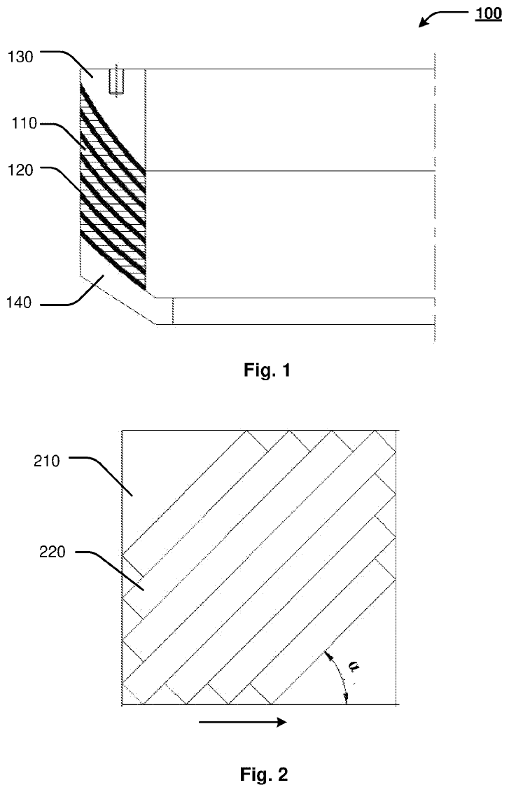

FIG. 1 illustrates a partial sectional view of an example seal, in accordance with an embodiment of the present subject matter. In an example, a seal 100 comprises alternate layers of rigid shim 110 and elastomer layer 120, with an aft end ring 130 and a fore end ring 140. Herein, rigid shim 110 and elastomer layer 120 refer to cured shim and layer formed of cured intermediate elastomer, respectively. In an example, the fore end ring 140 and the aft end ring 130 may be disposed on two ends of the stack of rigid shims 110 and the elastomer layers 120. In another example, a dimension of the rigid shims 110 is larger than a dimension of the elastomer layers 120 such that the rigid shims 110 extend beyond the elastomer layers 120. In an example, when the seal is used in a rocket, the fore end ring 140 may be attached to a nozzle and the aft end ring 130 may be attached to a rocket motor. In an example, the seal 100 may be used for mounting a movable thrust nozzle to the rocket.

The seal 100 may be prepared by obtaining rigid shims 110, stacking the rigid shims 110 with intermediate elastomer layers to form alternate layers of intermediate elastomer layers and rigid shims 110, placing the stack of rigid shims 110 and intermediate elastomer layers in a seal mold, and curing the intermediate elastomer layers to form the flexible seal 100. The flexible seal 100 thus formed comprises a cured stack of layers of rigid shims 110 alternating with elastomer layers 120, wherein the rigid shims 110 comprise a cured resin-impregnated three-dimensional fabric having fibers disposed in three dimensions.

The rigid shims 110 may have a surface corresponding to that of concentric spheres and similarly, the surface of elastomer layers 120 may correspond to concentric spheres. Thus, when the rigid shims 110 and elastomer layers 120 are stacked in alternate layers, the stack may form a part of a sphere.

The rigid shims 110 comprise a resin impregnated and cured fabric, the fabric having a three-dimensional structure comprising fibers disposed in three-dimensions. The rigid shims 110 may be prepared by various methods, for example, starting from a resin impregnated cloth from which a three-dimensional resin impregnated fabric structure is formed or starting from a preform having the three-dimensional fabric structure which is subsequently impregnated with a resin.

FIG. 2 illustrates a top view of a resin impregnated cloth 210, in accordance with an embodiment of the present subject matter. The cloth 210 may be a two-dimensional cloth having fibers disposed in two dimensions, such as warp and weft. A rigid shim 110 may be prepared by cutting the cloth 210 impregnated with resin into strips 220. The cloth 210 impregnated with resin may also be called a prepreg. In an example, the resin may be an epoxy, for example, Epofine, along with a corresponding hardener. The cloth 210 may be a poly(acrylonitrile)-based carbon fabric. In an example, the cloth 210 impregnated with resin may be cut at an angle a to the warp of the cloth. In an example, the angle a may be 45°. The warp direction is shown by an arrow in FIG. 2. The strips 220 may be of any width as required based on the configuration of the seal 100. A width of the strip 220 may be more than a width of the rigid shim 110 to be prepared.

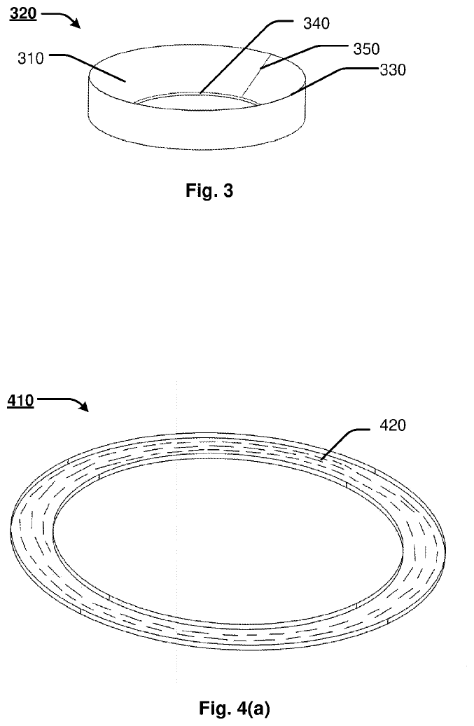

FIG. 3 illustrates an example female mold, in accordance with an embodiment of the present subject matter. Each of the strips 220 cut from the cloth 210 impregnated with resin may be laid around an inner circumference 310 of the female mold 320 in a layer by layer manner to form layered strips. The strips 220 are laid so that there is no fold or wrinkle in the fabric. The shape of the female mold 320 is based on the shape of the rigid shim 110 to be prepared. In an example, a shape of the female mold 320 may be similar to a three dimensional section cut from a sphere, with a first diameter 330 at one end larger than a second diameter 340 at the opposite end. As a result, the inner circumference 310 of the female mold 320 includes a curvature. The female mold 320 may be cleaned and coated with a release agent prior to laying down the strips 220 to facilitate removal of the strips 220 after curing to form the rigid shims 110. The strips 220 are laid continuously, similar to that of a coil, so that an edge of the strip 220 is aligned with an edge of the female mold 320. The width of the strip 220 may be the same as the width of an inner circumference 310 of the female mold 320. The start 350 of the strips 220 forms a bottom part of the bundle of strips that is formed subsequently. After one strip 220 ends, an end of the next strip 220 to be laid may be placed adjoining an end the first strip 220. The strips 220 may be laid down until a desired thickness is reached.

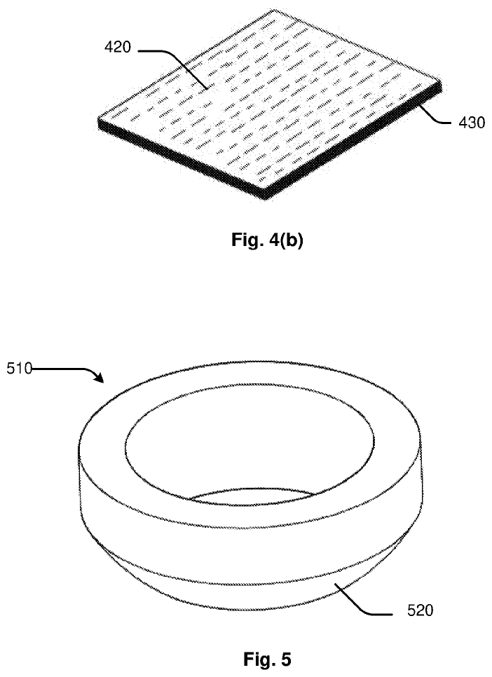

FIG. 4(a) illustrates a top view of an example bundle of strips formed by laying down strips in a female mold and FIG. 4(b) illustrates an exploded view of a portion of the bundle of strips, in accordance with an embodiment of the present subject matter. In an example, the strips 220 layered on each other in the female mold 320 and fastened together may form a bundle of strips 410. The thickness of the bundle of strips 410 may depend on the application. In an example, the thickness of the bundle of strips 410 may be between 6 and 8 mm. The different layers of the strip 220 may be fastened together to prevent delamination due to shear forces. In an example, the fastening may be done by sewing through the thickness of the different layers using, for example, a high strength fiber. The sewing may be done through the thickness of all the layers by forming stitches 420. In an example, the high strength fiber may be a carbon roving, for example, a T700 carbon roving. In another example, the fibers used for stitching may also be impregnated with resin. In another example, the fastening may be done using adhesives. Referring to FIG. 4(b), as shown in the exploded view, layers 430 of the strips 220 are stacked and fastened together to form the bundle of strips 410. The stitches 420 may be placed all along the circumference of the bundle of strips 410, thus forming a resin-impregnated bundle of strips 410.

FIG. 5 illustrates an example male mold, in accordance with an embodiment of the present subject matter. Once the layers 430 in the bundle of strips 410 in the female mold 320 are fastened together, a male mold 510 is placed over the bundle of strips 410. Before placing on the female mold 320, the male mold 510 may be cleaned and coated with a release agent. The male mold 510 has a shape corresponding to that of the female mold 320 so that a surface 520 of the male mold 510 fits onto the bundle of strips 410 when the male mold 510 is placed over the bundle of strips 410 on the female mold 320.

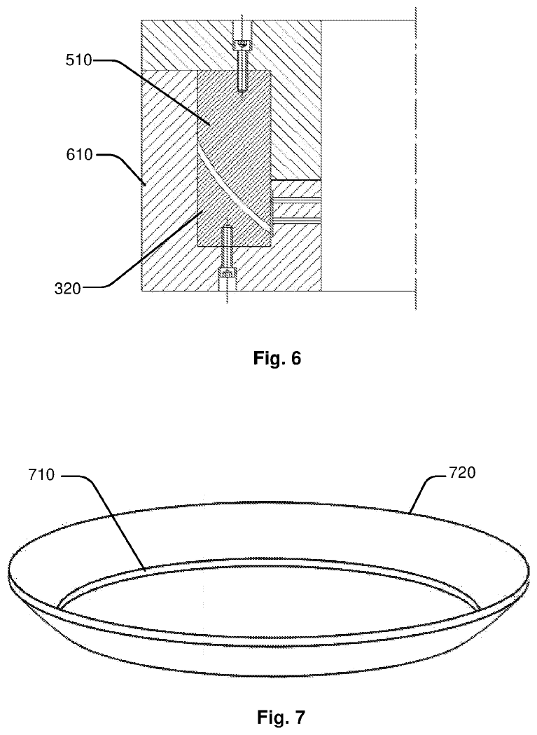

FIG. 6 illustrates an example mold base with a male mold and a female mold, in accordance with an embodiment of the present subject matter. The male mold 510 and the female mold 320 may be placed in a mold base 610 separated by the bundle of strips 410 so that the surface 520 of the male mold 510 is in contact with the bundle of strips 410. The bundle of strips 410, which is composed of cloth impregnated with resin, may be cured at the appropriate conditions of temperature and pressure. In an example, the curing conditions may be 160° C. for 3 hours at 100 bar pressure. During this process, as pressure is applied, the male mold 510 and female mold 320 move closer, the bundle of strips 410 is debulked, and the desired thickness of the rigid shim 110 is achieved. In an example, the thickness of the rigid shim may be controlled by a mechanical stopper incorporated in either the female mold 320 or the male mold 510.

FIG. 7 illustrates an example shim after curing, in accordance with an embodiment of the present subject matter. Once the three dimensional bundle of strips of resin impregnated cloth is cured to form the rigid shim 110, the male mold 510 and the female mold 320 may be removed from the mold base 610 and the rigid shim 110 may be removed from the female mold 320. In an example, after curing, the rigid shim 110 may have an inner diameter 710 and an outer diameter 720, which may both be machined to the desired dimensions.

Once the desired number of rigid shims 110 is prepared, the rigid shims 110 and intermediate elastomer layers may be stacked alternately. The fore end ring 140 and aft end ring 130 may be grit-blasted and placed on two ends of the alternate layers of the intermediate elastomer layer and rigid shim 110. In an example, the rigid shims 110 may be buffed on the top and bottom surfaces, wiped with solvent, and coated with an adhesive. The adhesive may be, for example, Chemlok 205, Chemlok 220, or other such adhesive.

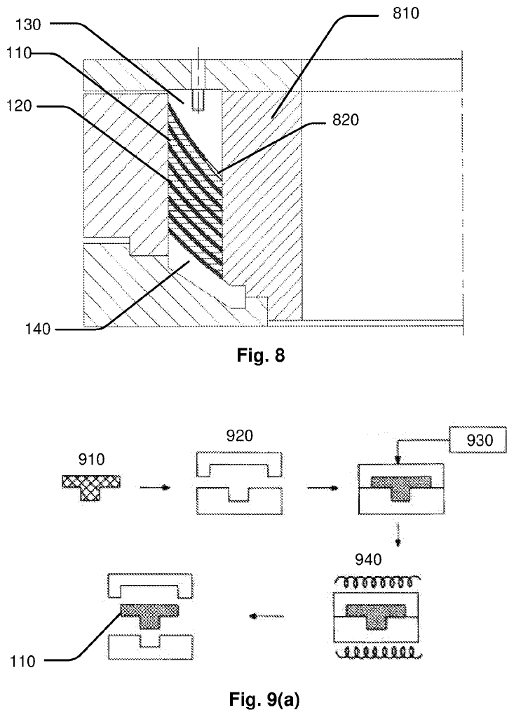

FIG. 8 illustrates a cross-sectional view of a seal mold for preparing an example flexible seal, in accordance with an embodiment of the present subject matter. The alternate layers of the cured rigid shim 110 and the intermediate elastomer layer stacked alternately may be placed in a seal mold 810. Spacer 820 may be placed between two rigid shims 110 to control the thickness of the elastomer layer 120. In an example, a plurality of spacers 820 may be placed at intervals along the circumference of each of the rigid shims 110. The intermediate elastomer layers may be cured at the appropriate curing conditions to form the elastomer layers 120. The curing conditions may be, for example, between 130 and 140° C. for 25 minutes. The spacer 820 may be removed after curing. In an example, the intermediate elastomer may be a composition comprising natural rubber. An example composition of the intermediate elastomer is shown in Table 1.

TABLE 1
Example Composition of Uncured Intermediate Elastomer

| | | Parts per |
|---|---|---|
| S. No | Ingredients | hundred |
| 1 | Natural Rubber | 100 |
| 2 | Zinc Oxide | 4.0 |
| 3 | Stearic Acid | 2.0 |
| 4 | Accinox TQ | 1.0 |
| 5 | Accinox ZC | 0.5 |
| 6 | GPF Black | 1.0 |
| 7 | Sulphur Crystex | 1.25 Max |
| 8 | MBTS | 0.25 |
| 9 | TMTD | 0.1 |

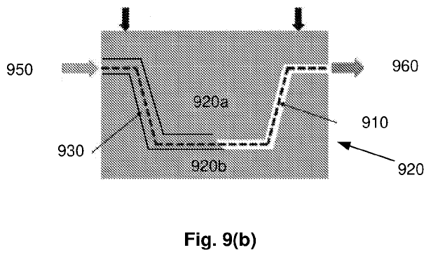

In another embodiment, the rigid shim 110 may be fabricated using a 3D preform. FIG. 9(a) illustrates a schematic illustration of preparing an example rigid shim 110 using a preform, in accordance with an embodiment of the present subject matter. A preform 910 may be a fabricated in the desired shape of the rigid shim 110 using a textile material by processes such as weaving, knitting, stitching, and braiding. The preform may be a three-dimensional fabric and accordingly, the textile fibers may be aligned along three-dimensions. In one example, the preform 910 is made of poly(acrylonitrile)-based carbon material. The preform 910 may be placed in a mold tool 920, after coating release agent is applied on the mold tool 920. Resin 930 may be impregnated in the preform 910 in the mold tool 920 and cured at the appropriate conditions. In one example, the resin 930 is an epoxy resin. After curing 940, the preform 910 impregnated with the resin 930 forms the rigid shim 110 and may be demolded from the mold tool 920.

FIG. 9(b) illustrates a schematic illustration of a method of resin impregnation in an example preform, in accordance with an embodiment of the present subject matter. In an example, the preform 910 may be placed in the mold tool 920. Two halves 920a and 920b may be clamped together with the preform placed in the mold tool 920. The resin 930 may be injected from a first side 950 of the mold tool 920. In an example, the resin 930 injection may be performed under pressure. Vacuum may be applied, if needed, from a second side 960 to enable the resin 930 to impregnate the preform completely. The flexible seal 100 may be then formed using the rigid shims 110 prepared from the preform as described earlier.

The flexible seal 100 prepared using the methods described above comprises a cured stack of layers of rigid shims 110 alternating with elastomer layers 120. The rigid shim 110 comprises three-dimensional fabric impregnated with resin and cured. The three-dimensional fabric may comprise stitches running through the thickness direction and provide additional strength to the flexible seal 100 or may be woven or prepared as a three-dimensional fabric with high structural integrity.

Although the present subject matter is described in language specific to structural features, it is to be understood that the specific features and methods are disclosed as example embodiments for implementing the claimed subject matter.

In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of producing a flexible seal, the method comprising:
obtaining rigid shims, wherein each rigid shim is a resin impregnated fabric having a three-dimensional structure comprising fibers disposed in three-dimensions;
stacking the rigid shims with intermediate elastomer layers to form alternate layers of intermediate elastomer layer and rigid shim;
placing the stack of rigid shims and intermediate elastomer layer in a seal mold; and
curing the intermediate elastomer layers to obtain the flexible seal having alternate layers of rigid shims and elastomer layers.

2. The method as claimed in claim 1, wherein obtaining the rigid shims comprises preparing a rigid shim by:
cutting a cloth impregnated with resin into strips;
laying each of the strips around an inner circumference of a female mold in a layer by layer manner to form layered strips;
fastening the layered strips together to form a bundle of strips;
placing the female mold comprising the bundle of strips and a corresponding male mold in a mold base; and
curing the bundle of strips to obtain the rigid shim.

3. The method as claimed in claim 2, wherein the cloth impregnated with resin is cut at an angle of 45° to warp of the cloth.

4. The method as claimed in claim 2, wherein a width of the strips is more than a width of the rigid shim to be prepared.

5. The method as claimed in claim 2, wherein a width of the strips is equal to a width of the inner circumference surface of the female mold.

6. The method as claimed in claim 2, wherein the fastening is performed by sewing using a high strength fiber.

7. The method as claimed in claim 6, wherein the high strength fiber is a carbon roving.

8. The method as claimed in claim 1, wherein obtaining the rigid shims comprises preparing a rigid shim by obtaining a preform of a three-dimensional fabric and impregnating the preform with the resin.

9. The method as claimed in claim 2, wherein the cloth is a poly(acrylonitrile)-based carbon material.

10. The method as claimed in claim 1, wherein the resin is an epoxy.

11. The method as claimed in claim 1, wherein the intermediate elastomer layer comprises a natural rubber.

12. The method as claimed in claim 1, wherein the intermediate elastomer layer comprises 100 ppm natural rubber, 4 ppm zinc oxide, 2 ppm stearic acid, 1 ppm Accinox TQ, 0.5 ppm Accinox ZC, 1 ppm GPF Black, up to 1.25 ppm Sulfur Crystex, 0.25 ppm MBTS, and 0.1 ppm TMTD.

13. A flexible seal, comprising:
a cured stack of layers of rigid shims alternating with elastomer layers, wherein the rigid shims comprise a cured resin-impregnated three-dimensional fabric having fibers disposed in three dimensions.

14. The flexible seal as claimed in claim 13, comprising a fore end ring and an aft end ring disposed on two ends of the stack of rigid shims and elastomer layers.

15. The seal as claimed in claim 13, wherein a dimension of the rigid shims is larger than a dimension of the elastomer layers such that the rigid shims extend beyond the elastomer layers.
